(19) United States
(12) Patent Application Publication
(10) Pub. No.: US 2014/0231044 A1
(43) Pub. Date: Aug. 21, 2014

(54) AIR MANAGEMENT SYSTEM

(71) Applicant: A Innovations, LLC, Greenwood Village, CO (US)

(72) Inventors: Daniel Duchesne, Parker, CO (US); Jeffrey Matthew Watson, Denver, CO (US)

(73) Assignee: A Innovations, LLC, Greenwood Village, CO (US)

(21) Appl. No.: 14/187,137

(22) Filed: Feb. 21, 2014

Related U.S. Application Data
(60) Provisional application No. 61/767,697, filed on Feb. 21, 2013.

(51) Int. Cl. A01G 9/24; F24F 13/02

(52) U.S. Cl. CPC A01G 9/246; F24F 13/02
USPC 165/53; 454/249

(57) ABSTRACT

Systems and methods are disclosed of removing heat generated by lighting, e.g., in an indoor grow environment. An example method includes providing a first manifold with an inlet to receive cool air, and a plurality of outlets. The example method also includes providing a second manifold with a plurality of inlets to receive air, and an outlet. The example method also includes providing ducts connecting the outlets of the first manifold to the inlets of the second manifold. The example method also includes connecting the ducts to lighting fixtures of the indoor grow environment, for air to move through the ducts. The example method also includes providing an air mover to pull air through the manifolds and ducts and remove heated air from an area of the lighting fixtures.

### PRIORITY CLAIM

This application claims the benefit of U.S. Provisional Patent Application No. 61/767,697 filed Feb. 21, 2013 titled “Airflow Manifold System and Methods” of Duchesne, et al., hereby incorporated by reference in its entirety as though fully set forth herein.

### BACKGROUND

Indoor grow environments are often established in colder geographies to extend the growing season, by using artificial light and/or heat. Indoor grow environments may also provide a controlled environment for plants in other geographies and/or climates (e.g., in high heat climates or during drought conditions). Artificial lighting may be used when natural sunlight is limited or unavailable, and/or to extend growing time, such as after the sun has gone down. In any case, artificial lighting produces heat, which in many cases has to be managed.

### BRIEF DESCRIPTION OF THE DRAWINGS

FIG. 1 is a schematic illustration of an example air management system.

FIG. 2 is an illustration of an example air manifold.

FIGS. 3a-h illustrate assembly of an example air manifold.

FIGS. 4a-e are schematic illustrations showing example configurations of an air management system.

FIG. 5 shows an example configuration of an airflow management system as it may be installed hanging over an indoor grow environment including lighting.

### DETAILED DESCRIPTION

An air management system is disclosed as it may be implemented by way of illustration to remove heat from indoor grow environments. In an example, the air manifold may mitigate heat buildup in a highly lighted environment, such as greenhouses or other grow environments. In other examples, the air management system may be used to mitigate heat generated by lighting in other environments, such as but not limited to, production sets in the film or television industry.

An example system may be implemented as a ventilation system for heat generated by lighting. The system may include a first manifold having a primary chamber having an inlet to receive an airflow, and a plurality of collars that serve as outlets for the airflow. The system may also include a second manifold having a primary chamber with a plurality of collars fluidically connected (e.g., to connect a volume of air), via ducts, to the collars of the first manifold to receive the airflow from the primary chamber and/or connected hoods, and an outlet to remove the airflow from the primary chamber. The first manifold and the second manifold may be connected by one or more duct lines and/or hoods, being inlets for air intake, e.g., for use at an indoor grow environment or other area in which airflow is managed.

It is noted that any number of manifolds may be connected by ducts or lines, and/or hoods to accommodate various ventilation needs, combinations, or configurations.

In an example, the primary chambers are constructed from flat insulated duct board, which may be a fiberglass duct board. Other construction material including sheet metal such as galvanized mild steel or pre-insulated aluminum, or polyurethane or phenolic foam panels may be used. In addition, faced fiberglass blankets can internally line or externally wrap metal ducts. Flexible or fabric ducts may also be employed.

An air mover (e.g., a fan or pump) may provide the airflow to the first manifold, as to pull air into the first manifold, and/or in the secondary manifold, and/or other manifolds, to push and/or pull air out of the chamber.

In an example, the system can be readily installed using only a few tools and by those having little or no prior experience installing ductwork. By way of illustration, the system may be provided as a configurable installation system, including pre-selected components of the air management system. In an example, the configurable installation system is a starter kit including basic components to assemble the lighting system. The configurable installation system may also include one or more add-on kits, each including add-on components to reconfigure and/or extend the airflow management system.

An example air management system and configuration thereof may produce a 30 to 70 percent increase in heat removal (e.g., depending on design considerations such as fan characteristics). The example system and configuration may also produce an increased fresh air flow across lights in an indoor grow environment; and reduce or altogether prevent heat stress on the lighting system(s), thereby enabling a year-round indoor growing season (e.g., by maintaining a desired room temperature and a more controlled climate). The example system may also be resistant to mold and condensation.

Before continuing, it is noted that as used herein, the terms “includes” and “including” mean, but is not limited to, “includes” or “including” and “includes at least” or “including at least.” The term “based on” means “based on” and “based at least in part on.”

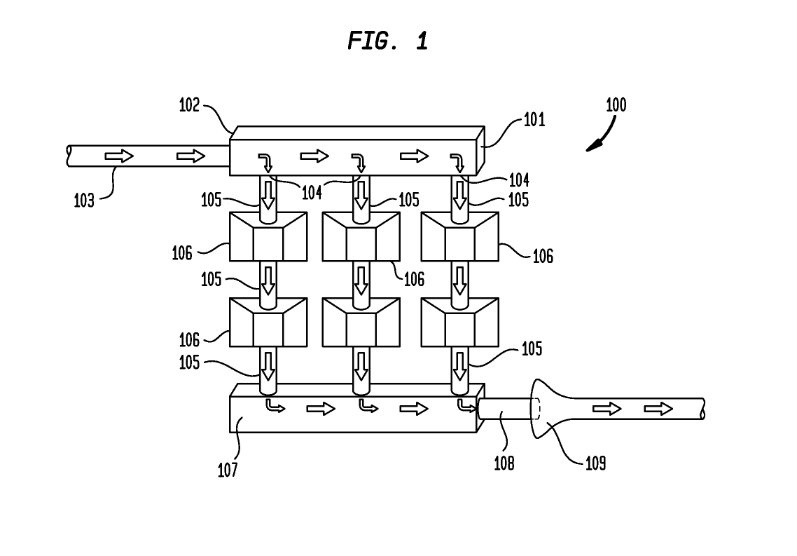

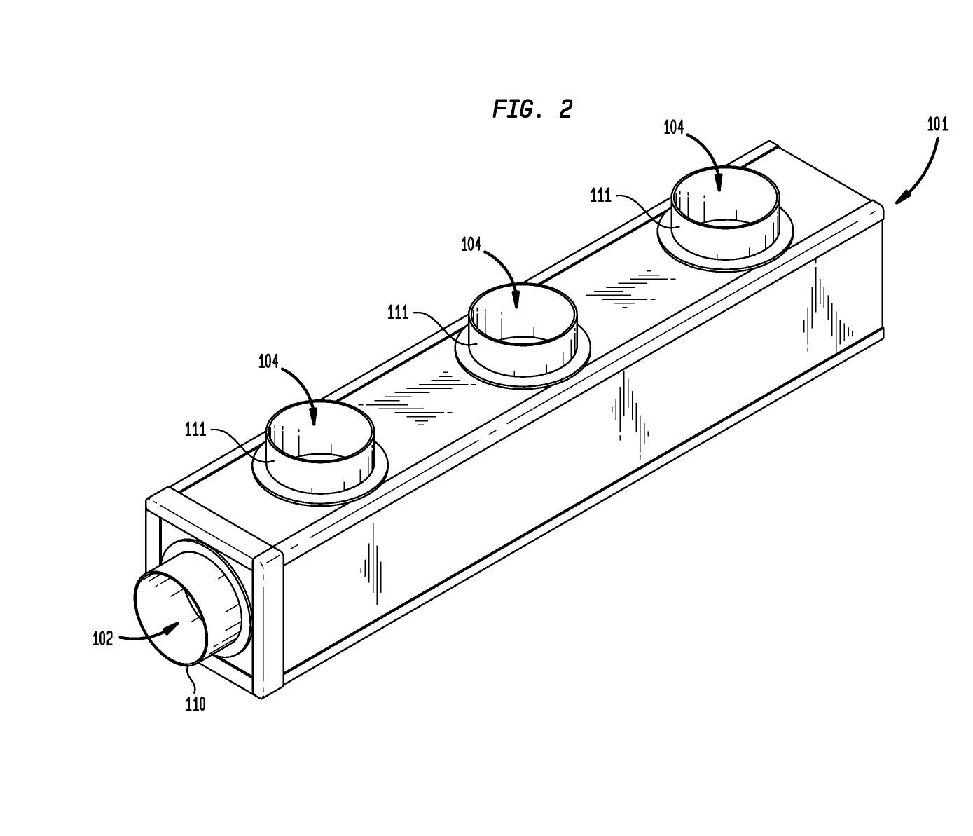

FIG. 1 is a schematic illustration of an example air management system 100. In the example shown, system 100 includes a first manifold 101 that may be configured to receive intake air (e.g., fresh, cool air) through one or more inlets 102 that may be connected to an inlet pipe 103 or duct. This duct may be for example, a ten inch diameter pipe. The first manifold may have outlets 104 formed by collars (not shown), that connect to ventilation ducts 105. The ventilation ducts 105 may connect to lighting fixtures being lighting hoods 106 in series and then to a second manifold 107. The ventilation ducts for example, may be six inches in diameter. The second manifold 107 has at least one outlet duct that, like the inlet duct 103, may be ten inches in diameter.

An outlet duct 108 may house an in-line fan 109 (or other air moving device) such that cool air is drawn or pulled (or pushed) from an outside source through the inlet duct 103 into the first manifold 101 and out into the ventilation ducts 105. The intake air then passes through the hoods 106, were it cools the lights housed therein, and into the second manifold 107 and out through the outlet duct 108.

Before continuing, it should be noted that the examples described above are provided for purposes of illustration, and are not intended to be limiting. Other devices and/or device configurations may be utilized.

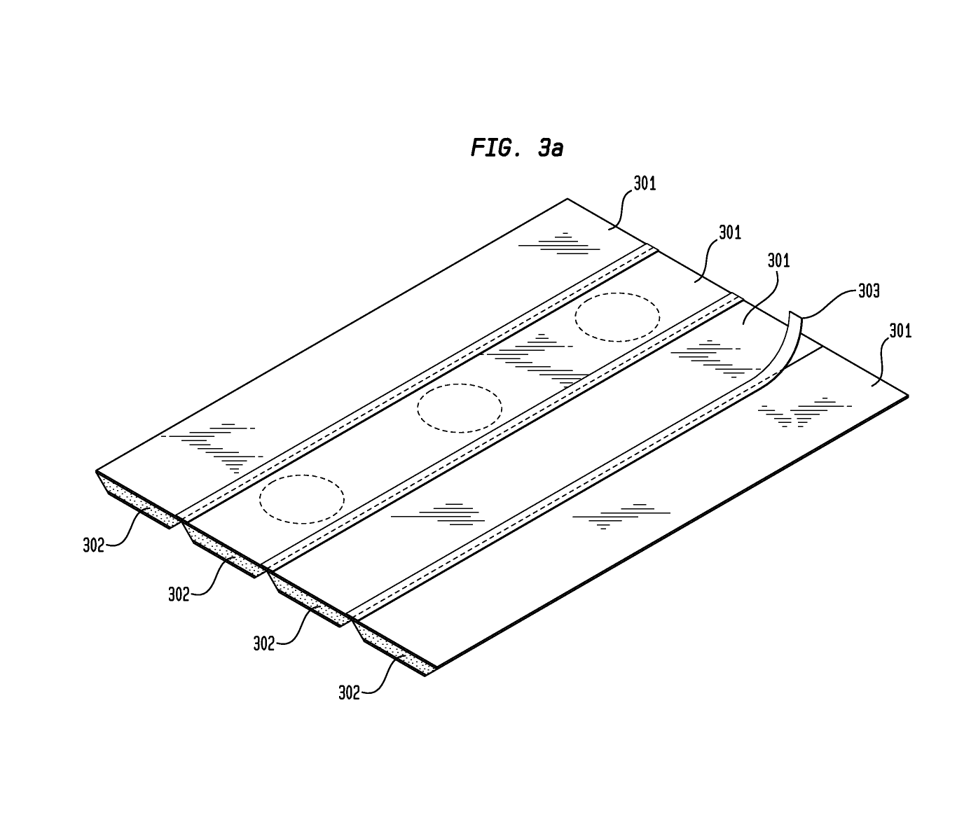

FIG. 2 is an illustration of an example air manifold 101. The example air manifold 101 shown is rectangular in shape, although it is not limited to shape or to any specific dimensions as to length or volume. At least one air inlet 102 for an opening in an end of the air manifold 101 and is bordered by a collar 110. Multiple air outlets 104 (three are shown in this example), are bordered by outlet collars 111, which may be of smaller diameter than that bordering the inlet 102.

The air inlet 102 is bordered by a collar 110, the diameter of which is just slightly smaller than the dimensions of the end of the manifold, and may be for example, about ten inches in diameter. This design allows for a maximum volume of air to be received into the manifold. One or more inlets of other dimensions may also be suitable. The three air outlets 104 are bordered by outlet collars 111. These outlets 104 and collars 111 are shown here with smaller diameter openings than that of the inlet, that may be about six inches in diameter, but other dimensions may be implemented based on application and/or other design considerations.

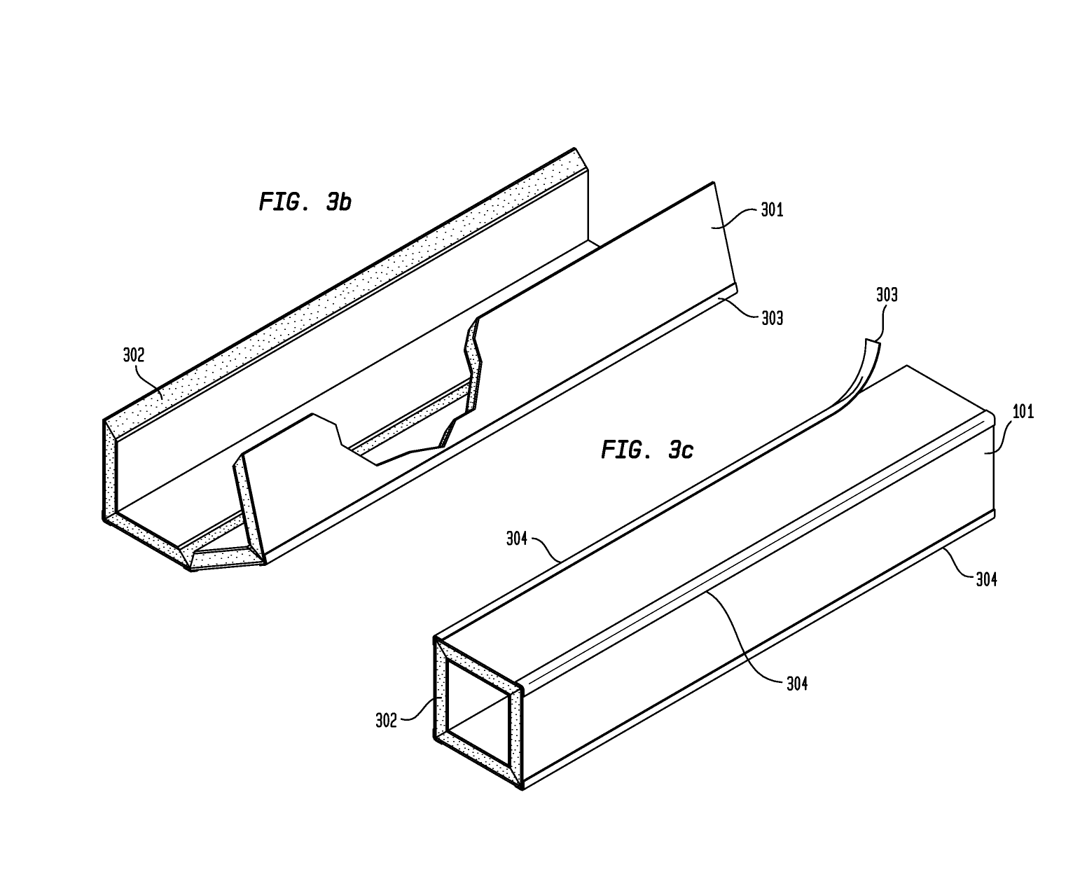

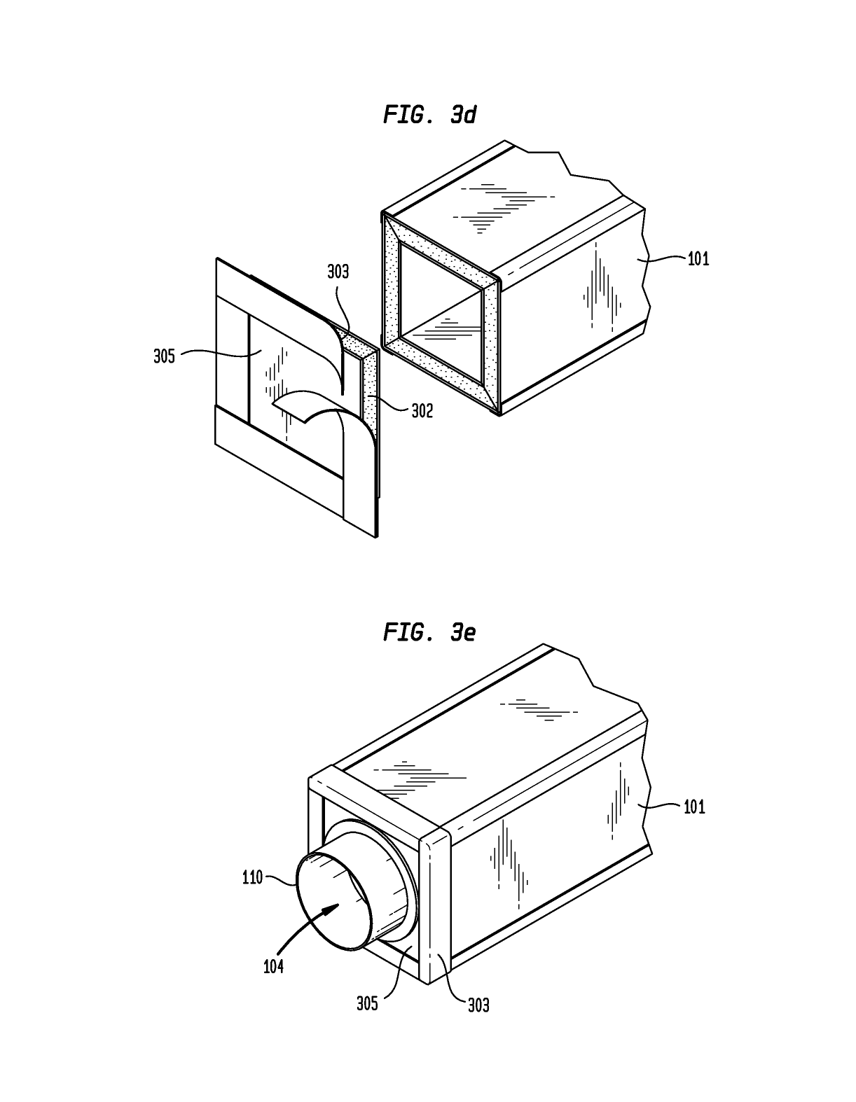

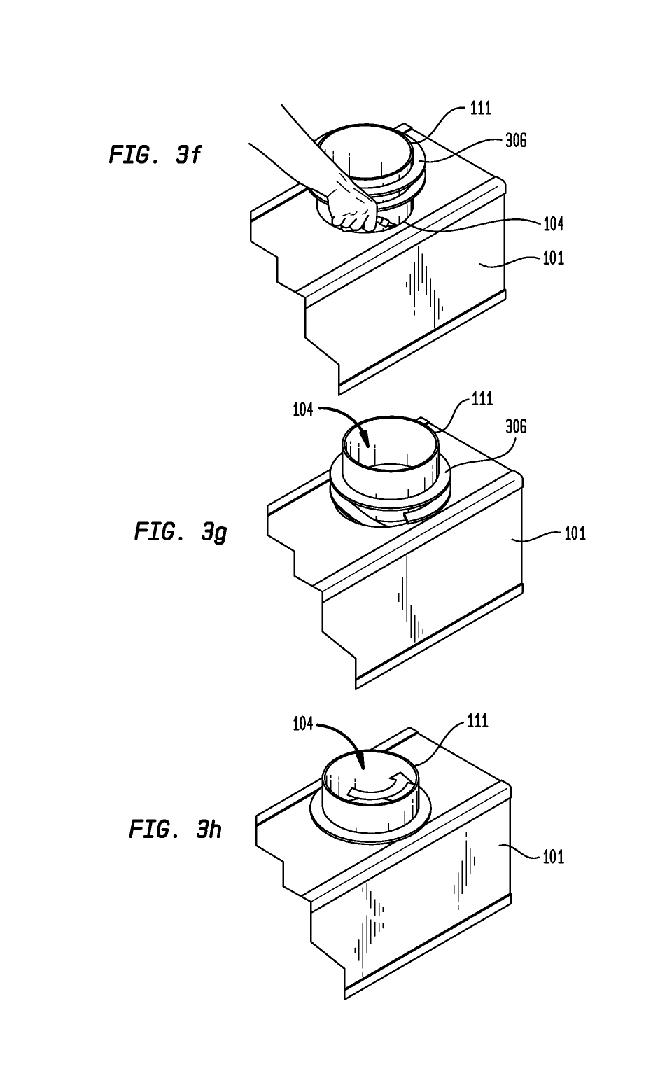

FIGS. 3a-h illustrate assembly of an example air manifold (e.g., the air manifold 101 shown in FIG. 2). The example airflow manifold 101 may be constructed from duct board 301 (or other suitable material), which includes insulation to reduce or eliminate condensate. The duct board is lightweight, easy to handle and work with, can be cut and folded for shipping, is mold resistant, and anti-microbial. It is noted however, that any suitable material may be used for the airflow manifold system.

As shown in FIG. 3a, the duct board may be provided in rectangular sheets 301, here being about five feet in length. The duct boards have a reflective (e.g., foil) sheet covering the insulation 302 on one side. The user lays sheets 301 of the duct board on the floor or other work surface with the reflective side up, and aligns these together so that the top and bottom are straight (e.g., the edges are aligned with one another). Strips of tape 303, which may be a duct tape, join the boards. Other methods of joining the boards may be used in other examples.

FIG. 3b illustrates four boards that have been connected (e.g., taped together). The boards are shown flipped over, reflective or insulation side 302 down, and are in the process of being folded into a rectangular shaped duct such that the insulation 302 is on an outer side of the folded duct. The duct board or other material that may form the manifold may be selected from one large sheet, or two or more smaller sheets. For example, only one seam need be taped or adhered together to form the single rectangular panel.

In another example if a sheet metal is used, a weld may be needed. Alternately, a slightly wider piece of sheet metal may be folded in to a rectangular duct with an overlap at the meeting sides. Rivets or other connectors may be used to connect the side pieces and duct tape may then be used to make the seal air tight.

FIG. 3c illustrates the next step of joining the two edges of the rectangular shaped duct board into a rectangular shaped three-dimensional manifold 101, such that the insulated 302 or reflective side is on the outside. Again in this example, a five foot piece of duct tape 303 is used to join the edges (although other attachments may be used). Additional pieces of tape 303 may also cover the other corner seams 304.

In FIG. 3d, an end cap 305 is shown formed of a square piece of duct board which has been precut to the correct dimensions, and laid on the work surface with the reflective or insulation side 302 facing up. In this case the end cap is approximately one foot by one foot in dimension. A foot long piece of tape 303, e.g., somewhat longer than one foot in length, is provided on each of the four sides of the end cap 305, such that the tape overhangs the edges with only about three-quarters of an inch, or about a third, of the tape being adhered to the end cap 305. Two end caps may be formed in this same way and fitted to the ends of the rectangular shaped duct to form the manifold 101.

As shown in FIG. 3e, the end cap 305 is positioned in one of the ends of the rectangular duct 303 that forms the manifold 101, and the tape is folded down as to join the end cap to one end of the manifold. In this example, an inlet hole 102 is cut to the correct size to receive a collar 110, and a collar is installed therein.

As shown in FIG. 3f, the user determines where, for example about three, 6/8 inch, outlet collars 111 should be placed for the ventilation ducts (not shown) to be fitted to. The collar can be placed upside down as a template for the outlet holes 104, and a marker may be used to trace around the collar. As shown the outlet holes 104 are cut (e.g., using a knife or a box cutter), and the duct strap 306 attached to the collar is pulled down to make the starting of a corkscrew.

As shown in FIGS. 3g and 3h, the duct strap 306 is pulled down into one of the cut holes 104, and as is shown in FIG. 3h, the collar is turned or rotated such that the duct strap 307 enables the collar to screw into the duct board (e.g., using both hands on the sides of the collar, staying away from the edges). The collar 110 is turned until the bottom is through the board.

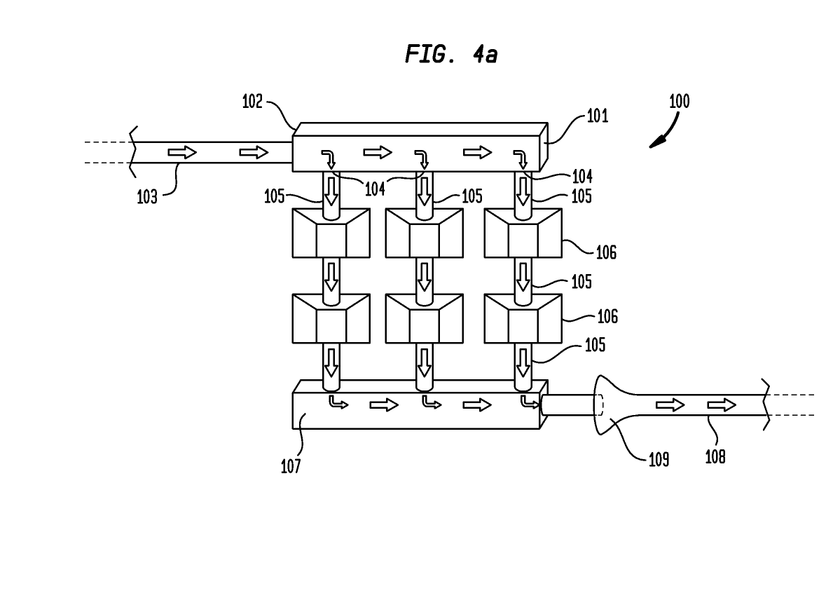

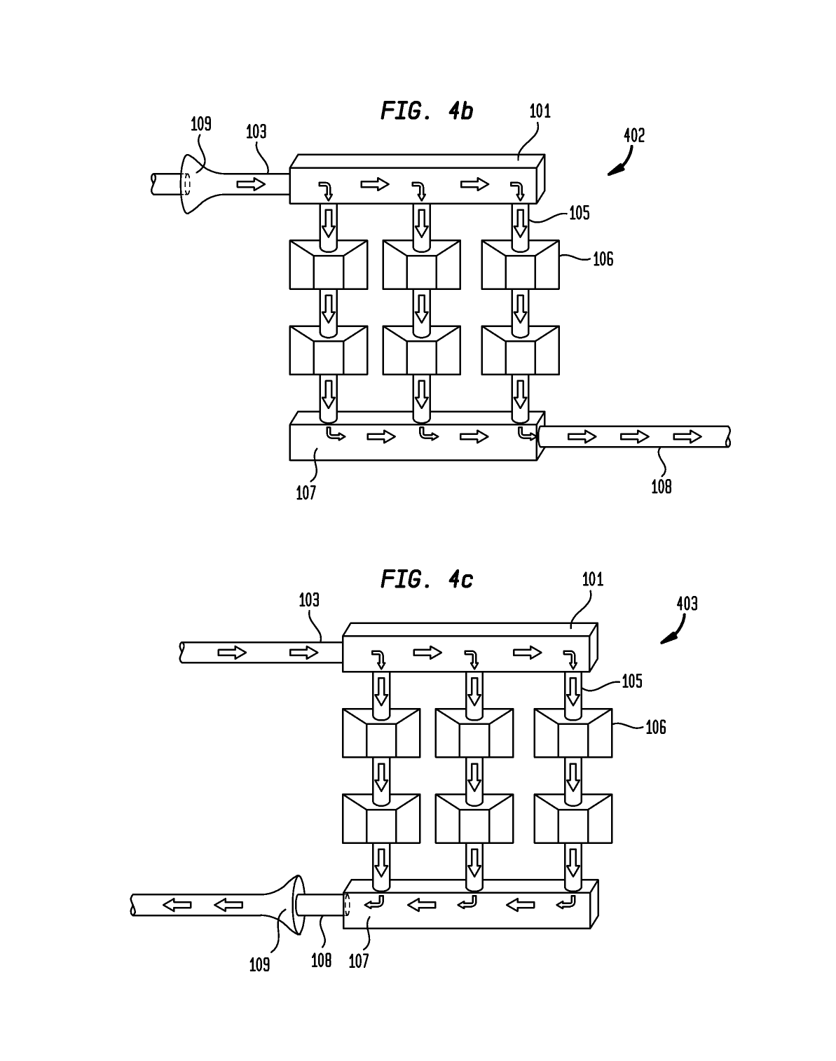

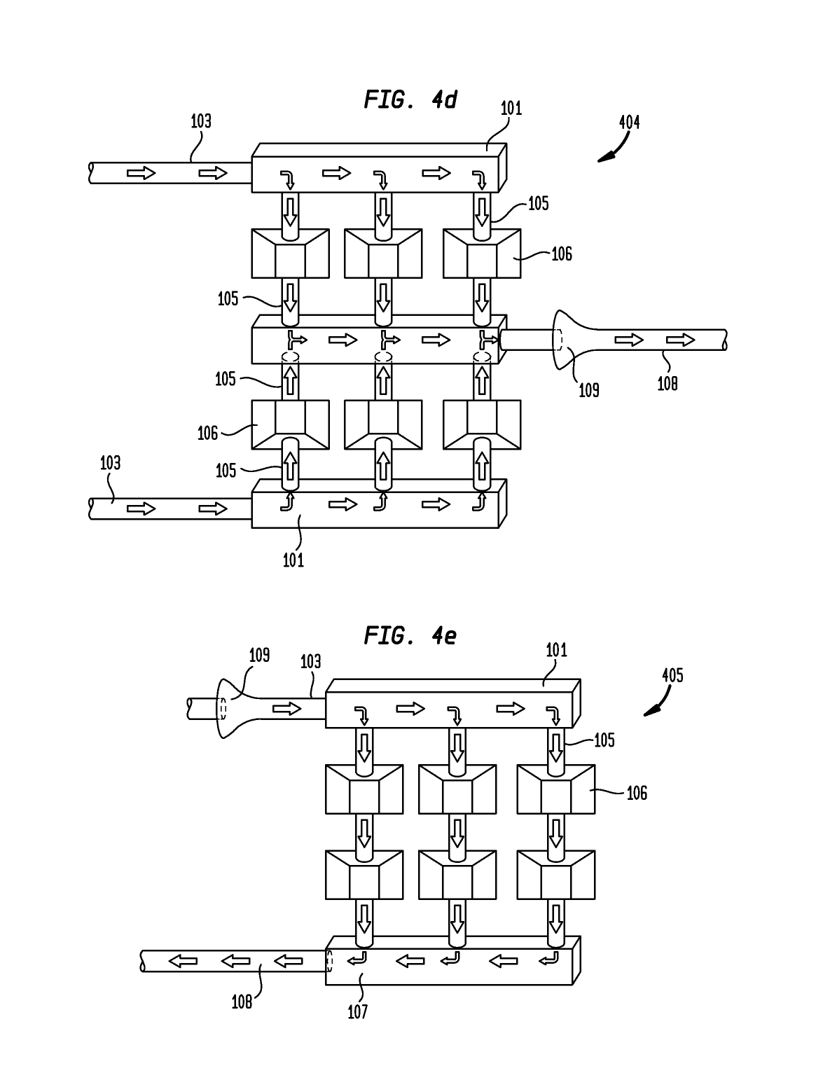

The steps shown in FIG. 3f-3h may be repeated for other outlet holes and collars to form the manifold 101. Steps shown in FIGS. 3a-3h can be repeated to make other manifolds, such as those illustrated in FIG. 2 and/or the components of the system shown in FIG. 1 or FIGS. 4a-4e.

It should be noted that the manifolds may alternately include inlets and/or outlets on both ends so as to accommodate various duct and hood arrangements and air flow needs.

The assembly shown and described herein is provided to illustrate example implementations. It is noted that the assembly is not limited to the ordering shown. Still other operations may also be implemented.

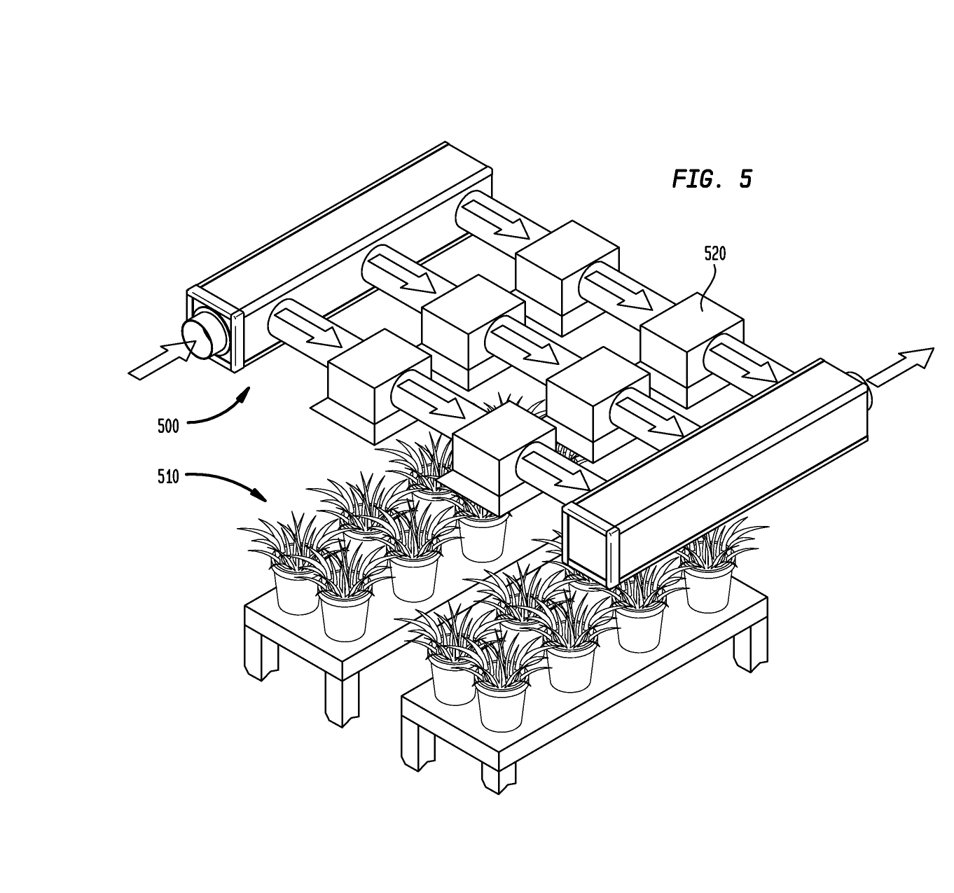

After assembling the airflow manifold, it can be mounted above the indoor grow or other environment (e.g., to the ceiling using duct strap and screws). An example configuration of an airflow management system 500 is shown as it may be installed hanging over an indoor grow environment 510 including lighting 520 is illustrated in FIG. 5. The arrows illustrate example air flow during operation. The example airflow manifold system 100 may be mounted to a ceiling, or other overhead fixture such as rafters, with duct strap and screws.

FIGS. 4a-e are schematic illustrations showing example configurations of an air management system. In an example, an inlet supply duct 103 can be pulled over the inlet starting collar and taped. The insulation is pulled over the duct, and then the plastic is pulled over the insulation and taped to the manifold, leaving substantially none of the collar showing (e.g., to prevent condensation). These operations may be repeated for the piece of ductwork running to the hoods and from the hoods to the second manifold and the outlet on the second manifold and/or ducts leading to an inline fan.

The outlet duct 108 can be extended from the fan to an outside unconnected environment, which may be another room or an outdoor environment. The fan can be connected to the power source, in an example, via a switch so that it will turn on and off with the lights and/or via a timer. All of the supply air ducts 105 from the manifold 101 are connected to the light hoods 106 and the ends taped. In an example, If two light hoods are used in series (e.g., in a row), a duct 105 may be installed in between these. A duct 105 is extended from the hood to the return manifold 107.

The fan 109 may be positioned so that it is at the end of the system to blow air out, thereby pulling the ductwork into a negative pressure and helping to keep the duct work up and out of the way. This also helps reduce or prevent outside air from coming into the room (e.g., from leaks around the hoods) if hoods are installed in a ceiling.

As shown in the example configuration of FIG. 4a, an airflow manifold system 100 may have a primary manifold 101 with an inlet 102 and connected inlet pipe or duct 103. Outlet holes 104 may be connected to ducts 105 and lighting hoods 106. Cool air is drawn into the primary manifold 101 and through ducts 105 to the hoods 106 thereby cooling the lighting fixtures. Additional air is draw into the ducts from the hoods as well. The air is pulled through another hood 106 and into the second manifold 107, out by an in-line fan 109 through an outlet duct 108 and then exits.

FIG. 4b shows another example configuration of an air management system 402. The system 402 has the in-line fan 109 positioned in the inlet duct 103.

FIG. 4c shows another example configuration of an air management system 403. System 403 has an outlet duct 108 positioned as to exit an environment on the same side that the inlet duct 103 is positioned.

FIG. 4d illustrates yet another configuration of an example manifold system 404, in which two primary manifolds 101 are utilized to draw in cool air through inlet ducts 103. The secondary manifold 107 is positioned between the light hoods 106 with the in-line fan 109 pulling heated air out through a mid-point in the environment.

FIG. 4e illustrates yet another configuration of an example manifold system 405, including an in-line fan 109 in the inlet duct 103. During operation, air exits through the outlet duct 108 on the same side of the environment.

Other configurations are also possible, as will be readily understood by those having ordinary skill in the art after becoming familiar with the teachings herein.

The example airflow manifold system and configuration provides substantially constant and/or even air supply/distribution over multiple ducts, such as may be implemented to cool lighting subsystems in an indoor growing or other heavily lighted environment.

An example airflow manifold system and configuration may have increased manifold duct size as compared with traditional ventilation systems, allowing for a larger volume of fresh air to reach the lights with only one penetration. A bigger duct size may be used to assist the fan to get closer to its true output. In an example, six inch ducts and openings can be used in each of two duct connected light hoods, for six stations in total that may be connected between the primary and secondary manifolds.

A ten inch air mover (or fan) can be used to move 700 cubic feet per minute (cfm) not restricted. But when adding duct work to the fan, the performance decreases. A 10 inch round duct moves 410 cfm at 1 inch duct static pressure, and a 6 inch round moves 110 cfm at 1 inch duct static pressure. So if three, 6 inch takeoffs are located on the manifold, the output through the example airflow manifold system and configuration can reach 330 cfm. It is noted that these numbers vary based on other design considerations (sizing, fan output, etc.). But with everything else held constant, as comparison when running six light hoods with one 6 inch round through all of the lights, only 110 cfm is produced.

The example airflow manifold system and configuration is also better at removing heat because it is moving two-thirds more air. Not only is more air supplied to the lights, but the example airflow manifold system and configuration supplies fresh air to the first three light hoods, and cool (albeit warmer than the first three light hoods) to cool the second hood in the series.

Components for the airflow manifold system as illustrated in FIG. 1 or FIGS. 4a-4e may be provided as a kit for those wishing to provide a ventilation system, e.g., for a lighting system. Further, components of an additional manifold with connected collars, ducts, and inlet and/or outlet duct components may be provided separately, e.g., as an addition to the starter kit. Components of a larger secondary manifold with associated collars and ducts may be offered separately or with either of the above to provide optional system configurations to the user. Further an appropriate air mover may be provided with any of the kits and/or additional parts described. In addition the airflow manifold system components may be bundled with lighting hoods and fixtures to offer a user a complete lighting and ventilation system.

It is noted that the examples shown and described are provided for purposes of illustration and are not intended to be limiting. Still other examples are also contemplated.

1. An air management system to remove heat generated by lighting, the system comprising:
a first manifold having at least one inlet and at least one outlet;
a second manifold having at least one inlet and at least one outlet;
ducts connecting the at least one outlet in the first manifold to the at least one inlet in the second manifold, wherein lighting fixtures are fluidically connected to the ducts for air to flow through the lighting fixtures.

2. The airflow management system of claim 1 further comprising an air mover.

3. The airflow management system of claim 2, wherein the air mover is a fan.

4. The airflow management system of claim 3, wherein the fan is positioned in the outlet of the second manifold and is configured to pull air through the first and second manifolds and into an external environment.

5. The airflow management system of claim 3, wherein the fan is positioned in the inlet of the first manifold and is configured to pull cooler air into the first and second manifolds.

6. The airflow management system of claim 1, wherein the first and second manifold are constructed of insulated duct board.

7. The airflow management system of claim 1 further comprising a third manifold connected to the first and second manifolds.

8. The airflow management system of claim 7, wherein the first and second manifolds both are configured as inlet manifolds to pull air from an external environment, and the third manifold has an outlet with an in-line air mover to push air.

9. The airflow management system of claim 7, wherein the third manifold is positioned between the first and second manifold.

10. The airflow management system of claim 1, further comprising at least three outlets in the first manifold, and three inlets in the second manifold.

11. The airflow management system of claim 10, wherein the first and second manifolds are constructed of insulated duct board.

12. The airflow management system of claim 1 further comprising an installation kit including components to assemble and install the airflow management system.

13. The airflow management system of claim 1 further comprising an add-on kit including components to extend assembly of the airflow management system.

14. A configurable airflow management system for an indoor grow environment, comprising:
a first manifold having a primary chamber having an inlet to receive an airflow, and a plurality of collars to remove the airflow from the primary chamber;
a second manifold having a primary chamber having a plurality of collars fluidically connected to the collars of the first manifold to receive the airflow, and an outlet to remove the airflow from the primary chamber; and
wherein the first manifold and the second manifold are connected over the indoor grow environment so that the airflow removes heat generated by lighting of the indoor grow environment.

15. The configurable airflow management system of claim 14, wherein the primary chambers are constructed from flat, insulated duct board.

16. The configurable airflow management system of claim 14, further comprising an air mover to provide the airflow to the first manifold.

17. The configurable airflow management system of claim 14, further comprising a plurality of air manifolds connectable to one another in a plurality of different configurations, each configuration for a different indoor grow environment.

18. The configurable airflow management system of claim 14, further comprising a plurality of ducts connectable to the manifolds in a plurality of different configurations.

19. The configurable airflow management system of claim 14, further comprising a plurality of air manifolds connectable to the lighting of the indoor grow environment in a plurality of different configurations.

20. A method of removing heat from an indoor grow environment, comprising:
providing a first manifold with an inlet to receive cool air, and a plurality of outlets;
providing a second manifold with a plurality of inlets to receive air, and an outlet;
providing ducts connecting the outlets of the first manifold to the inlets of the second manifold;
connecting the ducts to lighting fixtures of the indoor grow environment, for air to move through the ducts; and
providing an air mover to pull air through the manifolds and ducts and remove heated air from an area of the lighting fixtures.
